(19) United States
(12) Patent Application Publication
(10) Pub. No.: US 2026/0087583 A1
(43) Pub. Date: Mar. 26, 2026

(54) Direct Host Submission to Graphics Processor

(71) Applicant: Apple Inc., Cupertino, CA (US)

(72) Inventors: Steven Fishwick, St Albans (GB); David A. Gotwalt, Winter Springs, FL (US); Jackson Dsouza, Fremont, CA (US); Jairaj Dave, Hemel Hempstead (GB); Jatin Kumar, Santa Clara, CA (US); Piotr A. Dittrich, London (GB); Pratik Chandresh Shah, Santa Clara, CA (US); Ryan J. O'Shea, London (GB); Subodh Asthana, Fremont, CA (US)

(21) Appl. No.: 18/962,328

(22) Filed: Nov. 27, 2024

Related U.S. Application Data
(60) Provisional application No. 63/699,409, filed on Sep. 26, 2024.
(60) Provisional application No. 63/699,403, filed on Sep. 26, 2024.

(51) Int. Cl. G06T 1/20; G06F 9/48; G06F 9/54; G06T 1/60

(52) U.S. Cl. CPC G06T 1/20; G06F 9/4881; G06F 9/54; G06T 1/60; G06F 2209/543

(57) ABSTRACT

Disclosed embodiments relate to submitting tasks to a graphics processor directly by a host processor. In some embodiments, a graphics processor includes control circuitry that schedules and distributes portions of sets of assigned graphics work to multiple different graphics processor sub-units. A processor may execute a driver program for the graphics processor and a program that coordinates with the driver program to send work to the graphics processor, including to: store, in memory circuitry, configuration register data and queued sets of graphics work to be executed by the graphics processor and transmit a signal, to the control circuitry of the graphics processor, to change status of queued sets of graphics work in the memory circuitry. In response to the signal, the control circuitry may schedule and distribute the queued sets of graphics work. This scheduling may be performed without assistance of a firmware processor, which may improve overall performance.

### CROSS REFERENCE TO RELATED APPLICATIONS

The present application claims priority to U.S. Provisional App. No. 63/699,403, entitled “Graphics Processor Power Management Controlled by Distribution Hardware,” filed Sep. 26, 2024. The present application also claims priority to U.S. Provisional App. No. 63/699,409, entitled “Direct Host Submission to Graphics Processor,” filed Sep. 26, 2024. The disclosures of each of the above-referenced applications are incorporated by reference herein in their entireties.

This application is related to the following U.S. application filed on ______: U.S. application Ser. No. ______ (Attorney Docket Number 2888-77701/P67990US1), which is incorporated by reference as if entirely set forth herein.

### BACKGROUND

### Technical Field

This disclosure relates generally to graphics processors and more particularly to power management and kick distribution.

### Description of Related Art

Graphics processors (GPUs) typically use a firmware processor to program work received from a host (e.g., the central processing unit (CPU)). Distribution and scheduler circuitry such as a kickslot manager (KSM) absorbs work from the firmware processor and schedules the work across distributed GPU hardware (e.g., different shader cores, portions of a shader core, etc.). The firmware processor adds latency and power consumption to the scheduling process, however.

Traditionally, GPU software (e.g., on one or more firmware processors) programmed registers for sets of graphics work (which may be referred to as “kicks”) and handled powering various blocks on/off depending on functionality of the set of work. Distribution and scheduler circuitry may accelerate various aspects of register programming and otherwise prepare hardware for kicks, such that software may have a much more abstract view relative to the hardware. Software-based power control may therefore become less efficient (e.g., leave blocks powered on longer than needed) and may interfere with performance (e.g., by not powering on circuitry quickly enough for work that utilizes that circuitry).

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating example host-based submission of work to graphics slot manager circuitry, according to some embodiments.

FIG. 3 is a block diagram illustrating example power-on control techniques in the context of host-based submission, according to some embodiments.

FIG. 4 is a block diagram illustrating example hardware scheduler control of power gating of graphics processor circuitry, according to some embodiments.

FIG. 5 is a timing diagram illustrating example power control operations, according to some embodiments.

FIG. 6 is a timing diagram illustrating example power control operations with more granular control based on additional information available to slot manager circuitry, according to some embodiments.

FIG. 7 is a flow diagram illustrating an example method, according to some embodiments.

FIG. 8 is a flow diagram illustrating another example method, according to some embodiments.

FIG. 9 is a block diagram illustrating an example computing device, according to some embodiments.

FIG. 10 is a diagram illustrating example applications of disclosed systems and devices, according to some embodiments.

FIG. 11 is a block diagram illustrating an example computer-readable medium that stores circuit design information, according to some embodiments.

### DETAILED DESCRIPTION

In disclosed embodiments, a host processor (e.g., a CPU) is configured to directly schedule work via hardware GPU scheduler circuitry, without using a GPU firmware processor. For example, an executing application on the CPU may utilize a driver to enqueue work in DRAM queues and update queue status via control register writes. When a queue is ready to run (e.g., the driver makes a queue valid, adds a new kick to the front of a valid queue, clears an event flag that unblocks a queued kick, etc.), scheduler/distribution circuitry (e.g., kickslot manager (KSM) circuitry) on the GPU automatically schedules and distributes the kick, without using a GPU firmware processor to schedule the kick. In various embodiments, this may improve performance, improve security (e.g., by reducing reliance on code running on a GPU firmware processor), allow common GPU software scheduling techniques across different chip designs, or some combination thereof.

In some embodiments, the scheduler/distribution circuitry signals directly back to the CPU when results for a set of graphics work are available in a completion queue. Consider the following firmware-processor-based approach in contrast with disclosed embodiments: the host CPU communicates with the firmware processor and stores work in memory queues, the firmware processor would facilitate configuring a top slot in the kickslot manager, the kickslot manager would work with data manager circuitry to distribute and execute the work, results would be stored in a completion queue, the firmware processor would perform end-of-kick processing and notify the host CPU, and the host CPU would access results. In contrast, in disclosed embodiments the host GPU may enqueue work directly into a memory queue, notify the kickslot manager to configure a top slot, the data manager may facilitate work distribution and execution, the GPU may store results in the completion queue, and the kickslot manager directly informs the host CPU that results are available. This may substantially reduce latency in scheduling and completing kicks, in some embodiments.

In some embodiments, the host processor may ensure that the scheduler/distribution circuitry is powered on before submitting work. Further, the scheduler/distribution circuitry may facilitate waking shader core circuitry to complete the work, if needed. Note that while a “host” processor is discussed in various example embodiments, disclosed techniques may be used to allow various types of hardware to directly schedule work to a graphics processor, e.g., CPUs, firmware processors, processor of other system-on-a-chip components, fixed-function hardware, etc.

Note that details of queuing graphics work in memory queues and example slot-based distributed execution techniques are discussed in U.S. patent application Ser. No. 18/450,910 titled “Graphics Work Streaming Techniques for Distributed Architecture,” filed Aug. 16, 2023. The '910 Applicant is incorporated by reference herein in its entirety.

Generally, a hardware work scheduler may launch work on a distributed GPU and have visibility of where work is running, what resources work requires, what work will be scheduled soon, etc. Therefore, in disclosed embodiments, the scheduler/distribution circuitry may replace or augment software decisions regarding power gating various GPU circuitry. For example, because kickslot manager circuitry may know where every kick is running in a distributed GPU and which kicks are about to launch (e.g., based on DRAM queue status), disclosed techniques may allow the KSM to control powering blocks off. Therefore, KSM circuitry may look ahead and efficiently power down circuitry that will not be used, faster than software could have powered it down. In some embodiments, power control registers are accessible both to software and to the KSM. KSM circuitry may also decide to send an interrupt to power control firmware and let firmware decide whether to power a block down, in certain situations.

Hardware scheduler power control may be performed at various granularities, such as for groups of shader cores, per-shader-core, for individual circuitry within a shader core (e.g., fragment processing circuitry, a vertex pipeline, ray accelerator circuitry, a texture unit, etc.), and so on. The power control may be based on type of work available (or upcoming), sizes of sets of graphics work, queue priority, etc.

### Graphics Processing Overview

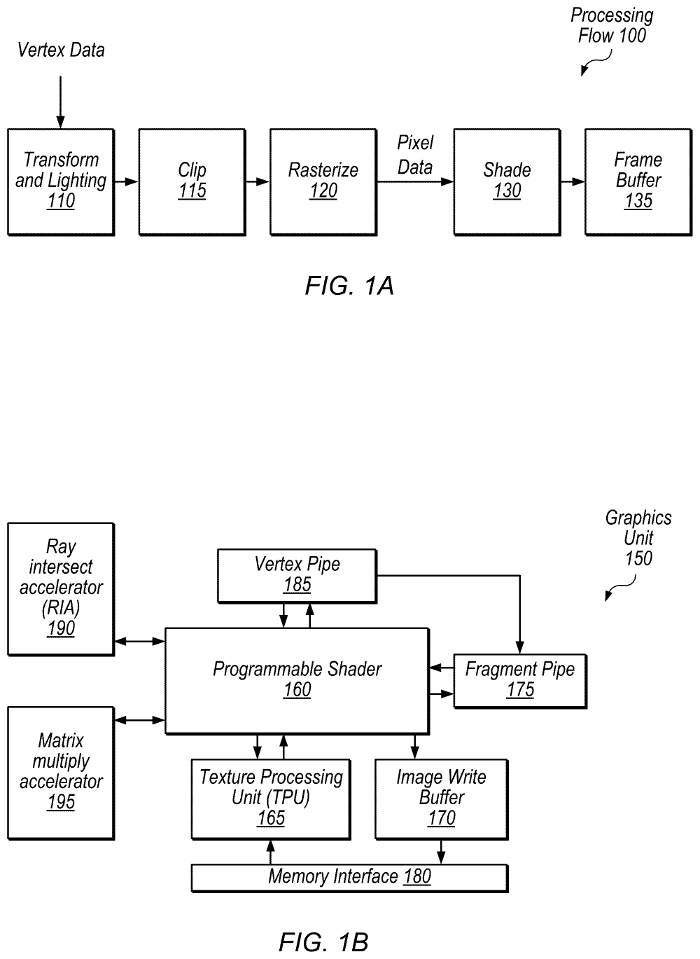

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes ray intersect accelerator (RIA) 190, which may include hardware configured to perform various ray intersect operations (e.g., for traversal of a bounding volume hierarchy acceleration data structure) in response to instruction(s) executed by programmable shader 160, as described in detail below.

In the illustrated example, graphics unit 150 includes matrix multiply accelerator 195, which may include hardware configured to perform various matrix multiply operations in response to instruction(s) executed by programmable shader 160, as described in detail below.

### Overview of Distributed GPU and Host-Based Work Submission

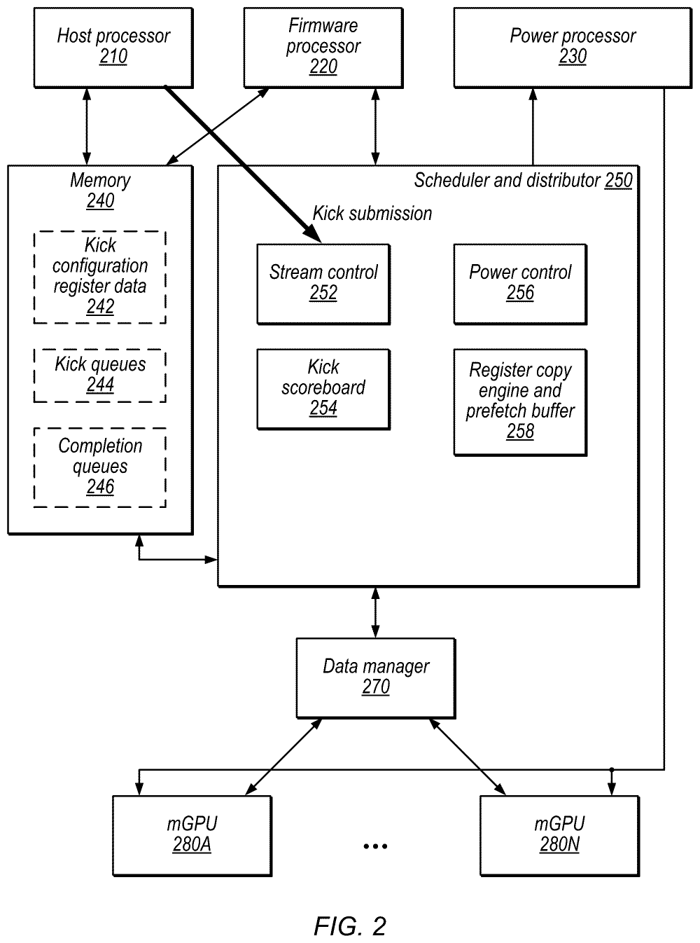

FIG. 2 is a block diagram illustrating an example computing system. In the illustrated example, the system includes host processor 210, firmware processor 220, power processor 230, scheduler and distributor circuitry 250 (one example of which is a kickslot manager), memory 240 (which may be a dynamic random access memory (DRAM)), data manager 270, and graphics processor sub-units or portions (mGPUs) 280A-280N. Circuitry 250 in turn includes stream control circuitry 252, kick scoreboard circuitry 254, power control circuitry 256, and register copy engine and prefetch buffer 258. In some embodiments, elements 220, 230, 250, 270, and 280 are included in a GPU while the host processor 210 and the GPU both have access to memory 240.

In some embodiments, the various illustrated components are included on a system on a chip. In these embodiments, the host processor may communicate with other components via an integrated communications fabric. In other embodiments, one or more components may be discrete and may communicate via an interface protocol that supports various disclosed signaling.

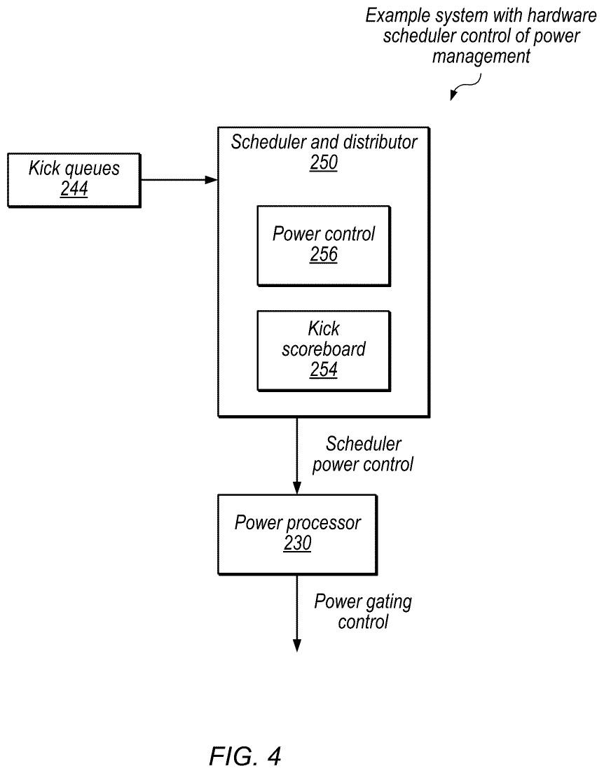

Power processor 230, in some embodiments, is configured to control power gating, power and performance states, or some combination thereof for the GPU. Note that power processor 230 and power control circuitry 256 are discussed in detail below with reference to FIG. 4 and therefore their detailed description is omitted here. Note that disclosed host-based submission techniques may be used alone, without scheduler power management techniques and vice versa, although these two techniques may be advantageously combined in various embodiments. Therefore, power processor 230 and power control circuitry 256 may be omitted, in some embodiments.

Host processor 210, in some embodiments, executes an application that has work to be executed on the GPU. Host processor 210 typically also executes a driver program for the GPU that facilitates various GPU operations by the application. Host processor 210 may utilize the GPU for various types of work, including rendering graphics frames, editing images or video, accelerating machine learning tasks, performing compute kernels that may not be graphics-related, etc. In some embodiments, host processor 210 generates sets of work referred to as kicks for the GPU.

Multiple “kicks” may be executed to render a frame of graphics data or for some other GPU task. In some embodiments, a kick is a unit of work from a single context that may include multiple threads to be executed (and may potentially include other types of graphics work that is not performed by a shader). A kick may not provide any assurances regarding memory synchronization among threads (other than specified by the threads themselves), concurrency among threads, or launch order among threads. In some embodiments, a kick may be identified as dependent on the results of another kick, which may allow memory synchronization without requiring hardware memory coherency support. Typically, graphics firmware or hardware programs configuration registers for each kick before sending the work to the pipeline for processing. Often, once a kick has started, it does not access a memory hierarchy past a certain level until the kick is finished (at which point results may be written to another level in the hierarchy). Information for a given kick may include state information, location of shader program(s) to execute, buffer information, location of texture data, available address spaces, etc. that are needed to complete the corresponding graphics operations. Graphics firmware or hardware may schedule kicks and detect an interrupt when a kick is complete, for example. In some embodiments, portions of a graphics unit are configured to work on a single kick at a time. This set of resources may be referred to as a “kickslot.” A kick may include a set of one or more rendering commands, which may include a command to draw procedural geometry, a command to set a shadow sampling method, a command to draw meshes, a command to retrieve a texture, a command to perform generation computation, etc. A kick may be executed at one of various stages during the rendering of a frame. Examples of rendering stages include, without limitation: camera rendering, light rendering, projection, texturing, fragment shading, etc. Kicks may be scheduled for compute work, vertex work, or pixel work, for example.

In some embodiments, a graphics driver, scheduler hardware, or both maps a new kick to one of multiple kickslots. Each kickslot may include a set of configuration registers and may have a context ID that indicates a mapping between the kick's virtual addresses and physical addresses.

Memory 240, in the illustrated example, is used to store various data structures for configuring work for the GPU, including kick configuration register data 242, kick queues 244, and completion queues 246. Host processor 210 may store kicks to be executed in one or more kick queues 244. Host processor 210 may also include control information such as dependencies for kicks (e.g., on other kicks or on events) that constrain when queued kicks are ready to launch. In some embodiments the device implements a unified memory architecture. Memory 240 may be a DRAM or some other level in a cache/memory hierarchy that is accessible to both the host processor 210 and the GPU.

Host processor 210 may also store configuration register data for kicks in data structure 242, which scheduler and distributor circuitry 250 may retrieve and provide to a data manger 270 to configure centralized control registers, de-centralized control registers in mGPUs, or both. The GPU may store data from completed kicks in completion queues 246 for use by host processor 210.

Firmware processor 220, in some embodiments, is configured to perform various tasks for the GPU, e.g., allocate memory, handle context switching, etc. Traditionally, a firmware processor would receive signaling relating to submitted work for the GPU from host processor 210 and perform various operations to configure and initiate the work. In contrast, in various disclosed embodiments host processor 210 is configured to submit and initiate work via direct communications with GPU hardware (e.g., circuitry 250), as discussed in detail below, potentially without communicating with the firmware processor at all. In these embodiments, firmware processor 220 may still perform tasks relating to context switches and memory allocation, for example, but may not be involved in receiving or launching work. Firmware processor 220 may also perform various monitoring and control operations relating to quality-of-service for the GPU (of which context switching is one example control operation), operations relating to power transitions, etc.

Data manager 270, in some embodiments, is configured to help manage a category of work (e.g., fragment work, vertex work, or compute work). For example, data manager 270 may distribute work from logical slots controlled by circuitry 250 to distributed hardware slots of mGPUs 280. There may be different instances of data manager 270 for different types of work. Further, data manager 270 may include a centralized portion that communicates with circuitry 250 and distributed portions in mGPUs 280. Generally, a data manager may interact with scheduler and distributor circuitry 250 to control execution of its category of work, retrieve input data for scheduled work of its category, update priority information for its category of work, etc.

mGPUs 280 may each implement multiple distributed hardware slots configured to receive portions of different kicks for execution via their shader pipelines. The '910 application provides various details regarding example mGPU embodiments and distributed hardware slots. For example, mGPUs, in some embodiments, are scaling units that may be replicated to increase the processing capabilities of a GPU. Each mGPU may be capable of independently processing instructions of a graphics program. mGPUs may include circuitry that implements respective distributed hardware slots. These hardware slots may also be referred to herein as “dSlots.” Each sub-unit may include multiple hardware slots. In some embodiments, primary control circuitry (e.g., the centralized portion of a data manager 270) assigns work from a logical slot to at most one distributed hardware slot in each mGPU. In some embodiments, each mGPU includes fragment generator circuitry, shader core circuitry configured to execute shader programs, memory system circuitry (which may include one or more caches and a memory management unit), geometry processing circuitry, and distributed workload distribution circuitry (e.g., a distributed portion of a data manager 270 which may coordinate with primary control circuitry to distribute work to shader pipelines).

Each distributed hardware slot may include various circuitry configured to process an assigned kick or portion thereof, including configuration registers, a distributed work queue, circuitry configured to iterate through work in the queue (e.g., batches of compute workitems), circuitry to sequence context loads/stores, and work distribution tracking circuitry. Each mGPU may include multiple shaders that accept work from distributed slots in the sub-unit and use pipelines to execute the work. For example, each shader may include a queue for each distributed hardware slot and may select work from among the queues based on work priority. In some embodiments, a given mGPU includes multiple programmable shaders 160 of FIG. 1B.

Scheduler and distributor circuitry 250, in the illustrated example, includes stream control circuitry 242, kick scoreboard 254, power control circuitry 256, and register copy engine and prefetch buffer 258. Generally, circuitry 250 is configured to assign/distribute and launch work based on signaling from host processor 210, without firmware processor 220 acting as a middleman. In the illustrated example, host processor 210 submits kicks directly to circuitry 250 via stream control 252. In some embodiments, this involves explicit signaling, e.g., to indicate that a kick is ready for scheduling. In other embodiments, this involves signaling that changes queue status, e.g., by writing to a control register in stream control 252, e.g., that adjusts event flags to clear a kick dependency, adds a kick to the head of a queue 244 that is ready to execute, changes the status of a kick queue 244 or adds a new queue 244, etc. In some embodiments, a programmable I/O write may be used to write to a control register of circuitry 250 (which may also wake circuitry 250, in some embodiments, if it is in a low power state). In some embodiments, kick submission signaling may be performed in whole or in part by changing data in memory 240, e.g., in one or more kick queues 244 (in those embodiments, circuitry 250 may poll the status of data in memory 240, for example).

In some embodiments, programmable I/O writes may utilize centralized gateway circuitry, which may reduce credit logic relative to non-centralized techniques, e.g., as described in U.S. patent application Ser. No. 18/404,822 titled “Centralized Non-System-Memory Gateway Circuit” and filed Jan. 4, 2024. Generally, programmable I/O commands are one example of transactions that do not utilize system memory to communicate between components of a system, e.g., a system-on-a-chip. Various such transactions may be utilized for host-based submission signaling.

Stream control 252, in some embodiments, is configured to select among queues in kick queues 244 that have work ready to schedule. In some embodiments, queue selection logic works in multiple phases, e.g., to identify all queues available to schedule work, read the kick entry indicated at the head of those queues from memory 240, process the kick entry to determine if the kick is able to schedule, rotate among queues and run a given kick that can schedule, go to sleep if no kick can schedule. Note that because many writes to the kick queues 244 by host processor 210 will be to the back of a queue, stream control 252 may handle corresponding register writes by performing the first phase and determine not to wake other GPU circuitry if the register update does not unblock any queues.

When a queue is selected, stream control 252 may inform register copy engine and prefetch buffer 258, which may prefetch configuration register data 242 from memory 240 into the prefetch buffer. Circuitry 250 may then utilize the prefetched control register data to populate various control registers for logical kickslots, distributed hardware kickslots, or some combination thereof. In embodiments without virtualization of hardware slots for sets of graphics work, circuitry 250 may utilize the register control data to populate control registers for hardware slots only.

Circuitry 250 or data manager 270 may include control stream processor circuitry (not explicitly shown) configured to manage sequencing of kickslots, fetch and execute the control stream for a kick, and track kick completion. Control stream processors may operate at kernel granularity (kernels may be fetched from the control stream for a kick). Control stream processors may communicate with a distributed slot (dSlot) resource allocator to obtain dSlot resources for their logical slot. Control stream processors may determine the distribution mode for kernels and send kernels with their distribution mode and distributed slot assignments to kernel processors. Generally, circuitry 250 may include various features for assigning kicks from queues 244 to distributed hardware slots (which may include assigning kicks to top slots, mapping top slots to logical slots, mapping logical slots to one or more hardware slots based on a distribution mode, etc.).

Stream control 252 may also include queue configuration registers, which it may use to configure kick queues 244. Firmware processor 220 may also access these queue-configuration registers, e.g., to manage context switches.

Kick scoreboard 254, in some embodiments, is configured to track various status information for kicks, including dependencies. Scoreboard 254 may also track the following information, discussed in detail below, in example embodiments: identifier, status, data identification, dependencies, run data, and configuration.

Each tracking slot may be assigned a unique identifier. Thus, the kickslot manager may support a maximum number of tracking slots. In various embodiments, the number of supported tracking slots may be selected such that it is fairly rare that enough small non-dependent kicks can be scheduled in parallel to use all available tracking slots. In some embodiments, the number of supported tracking slots is greater than the number of supported logical slots.

The status field, in some embodiments, indicates the slot's current state and whether the slot is valid. This field may also indicate the logical slot and any distributed slots assigned to the tracking slot, if applicable. In some embodiments, the status field supports the following status values: empty, programming done, register fetch started, waiting for parents, waiting for resources, waiting for distributed slots, running, halt requested, deallocating, de-queued by kickslot manager, de-queued by primary control circuitry, context stored, and complete. In other embodiments, the status field may support other states, a subset of the described states, etc.

The data identification field, in some embodiments, indicates the location of control register data for the kick. This may be specified as an initial register address and a number of configuration registers, for example. It may also include a register context identifier. In some embodiments, the data identification field also indicates other resources used by the kick, such as samplers or memory apertures. Some of these resources may be hard resources, such that the kick cannot proceed until they are available, while other resources may be soft resources and a kick may proceed without them or with only a portion of requested resources, in certain situations. As one example, memory apertures may be considered soft resources and kicks may be allowed to proceed even if their soft resources are not available (potentially with a notification sent to the requesting software).

The dependency field, in some embodiments, indicates any dependencies for the slot on kicks in other slots. As one example, scoreboard 254 may implement an N×N matrix (where N is the number of tracking slots) where each slot includes an entry for each other slot that indicates whether the slot depends on the other slot. Entries may be cleared as kicks from other slots complete. In other embodiments, dependencies may be encoded using other techniques. Kickslot manager circuitry may assign tracking slots to logical slots according to the indicated dependencies (e.g., by waiting to assign a kick to a logical slot until all tracking slots on which it depends have completed). Moving dependency tracking from software/firmware control to dedicated hardware may allow for more efficient use of logical slots and may reduce kick-to-kick transitions.

In some embodiments, the dependency field or a separate event dependency field also includes an event flag dependency mask based on system dependencies. In some embodiments, actions by host processor 210 may alter system event flags such that a kick in a kick queue becomes ready to launch.

The run data field, in some embodiments, provides information regarding the run status of kicks. For example, this field may indicate which hardware slots are running the kick. This field may also provide timestamps for assignment of a kick to a logical slot, when a kick begins running on distributed slots, and when a kick is finished. Various other performance or debug information may be indicated as well. In some embodiments, various tracking slot information is retained for slots with the retain field set and their mapped hardware resources are also not released (potentially allowing access to status registers at the logical slot level, distributed slot level, or both).

The configuration field, in some embodiments, indicates the type of data manager circuitry controlling the slot (e.g., compute, pixel, or vertex), the priority of the slot, a retain slots indication, a force end of kick interrupt indication, or any combination thereof. This configuration field may be programmable by software to indicate configuration of the slot and provide certain software override information, for example. An end of kernel interrupt may be set globally or may be set to trigger per kick (or to trigger after a threshold number of kicks). This may advantageously reduce time spent handling interrupts (by omitting interrupts in certain situations) while still retaining interrupt functionality when needed.

Register copy engine and prefetch buffer 258, in some embodiments, is configured to copy data from kick configuration register data 242 (e.g., utilizing direct memory access (DMA) functionality) to a prefetch buffer for register data, such that the prefetched configuration register data is ready to program configuration registers when circuitry 250 and 270 distributes a kick. In other embodiments, control circuitry may retrieve configuration register data when a kick is being scheduled, without prefetching.

In various embodiments, disclosed techniques for host processor 210 submitting work directly for scheduling by circuitry 250 may advantageously improve performance, e.g., by reducing latency relative to firmware processor 220 executing scheduling firmware. Further, disclosed techniques may improve security, e.g., by reducing software threat vectors relating to work scheduling and providing additional hardware control in conjunction with the graphics driver executed by host processor 210. Further, disclosed techniques may facilitate standardization across GPU implementations by providing a common interface structure to a host processor while circuitry 250 may handle various operations associated with a specific GPU design. Disclosed techniques may also allow the GPU firmware processor to improve its performance for other tasks (e.g., because it has offloaded some of its tasks to the host processor) or enable simpler firmware processors (e.g., in terms of circuit area, power, etc.).

### Example Power-on Techniques for Host-Based Work Submission

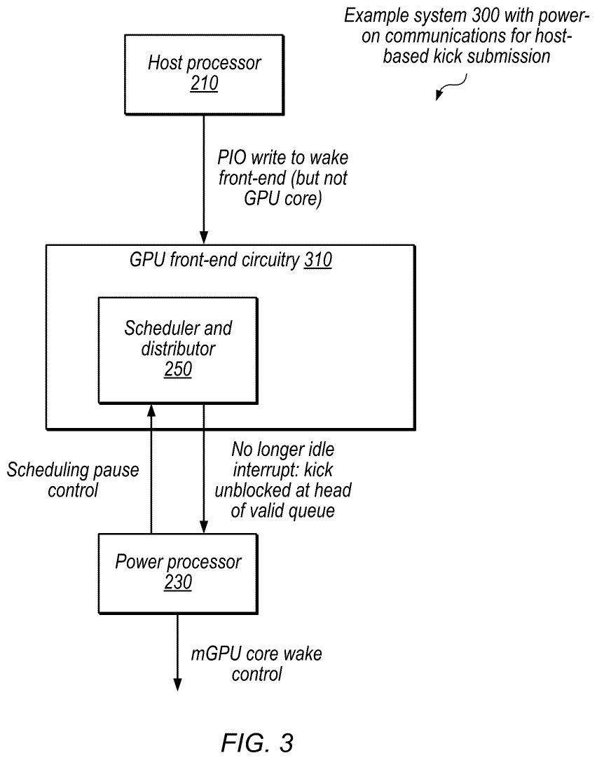

FIG. 3 is a block diagram illustrating example power control techniques in the context of host-based submission, according to some embodiments. In the illustrated example, at least a portion of circuitry 250 is included in GPU front-end circuitry 310, which may be in an always-on power island of the system, or a power island that is separately controlled (and typically “more-on”) than power island(s) for GPU shader cores that execute graphics work.

Generally, for host-based submission, host processor 210 may ensure that circuitry 250 is powered on and available before taking actions that cause kicks to be available to launch on the GPU. This may be important, given that firmware processor 220 would traditionally check that appropriate circuitry is powered on, but may no longer be involved in kick submission, in some embodiments.

In the illustrated example, host processor 210 is configured to send a programmable input/output (PIO) write to wake GPU front-end circuitry 310 before host-based submission of graphics work. Generally, the host processor 210 may be able to freely write to certain registers of control circuitry 250. If a register write results in the kick at the head of a valid queue becoming eligible to run, circuitry 250 may wake power processor 230, which may in turn wake other GPU circuitry as discussed below. If register write(s) to circuitry 250 by the host processor do not cause kicks to be eligible to run, front-end circuitry 310 may remain powered, but may not wake other GPU circuitry until a kick becomes eligible.

For example, circuitry 250 is configured to cause shader core circuitry to wake in certain scenarios (and power processor 230 may pause scheduling by circuitry 250 in some scenarios). In the illustrated example, when circuitry 250 detects an unblocked kick at the head of a valid queue, it sends a “no longer idle” interrupt to power processor 230. This may wake power processor 230, firmware processor 220, or both. Power processor 230 in turn wakes one or more mGPU cores. When the core(s) are awake, power processor 230 de-asserts the “scheduling pause” signal and circuitry 250 proceeds to schedule work from valid queue(s). For example, circuitry 250 may access memory 240 to retrieve kick configuration register data, program data manager circuitry, etc.

Various appropriate techniques may be used by host processor 210 to check or update power state of the GPU, including transmitting wake signals, status register polling, handshake signaling, etc.

### Example Scheduler Control/Input for Power Gating Decisions

FIG. 4 is a block diagram illustrating example hardware scheduler control of power gating of graphics processor circuitry, according to some embodiments. The illustrated example shows a subset of the circuitry shown in FIG. 2. In this example, circuitry 250 is configured to provide KSM power control signals to power processor 230. In other embodiments, circuitry 250 may provide power control signals directly to gating circuitry, alone or in combination with the illustrated signals to power processor 230.

Power processor 230, in some embodiments, is configured to control power gating, power and performance states, or some combination thereof for the GPU. Various portions of illustrated circuitry of FIG. 2 (or other circuitry) may be powered via gating circuitry such that those portions can be powered down when not in use. Power processor 230 may control the gating circuitry for these portions. For example, power processor 230 may be configured to power gate the entire GPU, a shader core, a portion of a shader core, individual mGPUs, portions of an mGPU (e.g., a fragment pipe 175, a vertex pipe 185, RIA 190, matrix multiply accelerator 195, etc.), or some combination thereof.

Power processor 230 may be a similar processor architecture to firmware processor 220 or a different architecture. In other embodiments, the functionality of processor 220 and processor 230 may be implemented by a single processor. In some embodiments, communications between host processor 210, firmware processor 220, and power processor 230 (or some combination thereof) are limited or eliminated, e.g., because circuitry 250 is configured to perform various tasks that might have previously utilized communications between those blocks. This may advantageously increase security of the overall system, in some embodiments.

Generally, power processor 230 may have less visibility (or slower visibility) into the current work distribution in the GPU and the upcoming work in kick queues 244, relative to scheduler and distributor circuitry 250. For example, as discussed above, kick scoreboard circuitry 254 may maintain various detailed information about currently-running or recently-executed kicks and circuitry 250 may have access to kick queues 244 in memory and register data 242 (in memory, in a prefetch buffer, or both) to determine various attributes of upcoming kicks. Therefore, power control circuitry 256 may utilize various information in kick scoreboard 254, kick queues 244, register data 242, or some combination thereof as inputs to generate power control signals.

For example, power control circuitry 256 may determine that an mGPU or portion of an mGPU becomes idle when it has finished its portion of a kick and additional work has not been scheduled (e.g., based on the status of top slots that are waiting to send work). In this case, circuitry 256 may gate the mGPU, faster than power processor 230 would have been able to detect the situation and initiate gating. As another example, even if an mGPU is executing work on one or more of its slots, that work may not target one or more portions of the mGPU (e.g., none of the executing kick(s) on that mGPU may utilize various specialized circuitry such as fragment pipe 175, vertex pipe 185, ray intersect accelerator 190, matrix multiply accelerator 195, or texture processing unit 165). In that case, circuitry 256 may power gate the untargeted portion of one or more mGPUs. Circuitry 256 may also examine queued kicks in kick queues 244 before power gating, e.g., to check if upcoming kicks are likely to target mGPU circuitry that otherwise might be power gated.

Note that various examples herein discuss power gating, but control circuitry may additionally or alternatively clock gate or control voltage or frequency levels in these examples. Generally, clock gating, power gating, and voltage control are examples of techniques that may reduce power consumption by idle hardware but may have different tradeoffs in terms of circuit costs, control granularity, effectiveness in reducing consumption, etc. Therefore, various examples that power down or power gate certain circuitry may clock gate or reduce the voltage to that circuitry, in other embodiments or situations.

Power control circuitry 256 may also maintain idle bits that indicate that all kicks using a given type of execution resource are idle. For example, if all kicks that utilize ray intersect accelerator 190 are idle, the idle bit for that execution resource may cause power control circuitry 256 to trigger a power down action for a ray intersect accelerator 190 of one or more mGPUs. Note that in embodiment that use separate data managers 270 for different types of work, power control circuitry 256 may also control the power state of the data managers depending on the type of work in active kicks.

In some embodiments, software may independently configure various aspects of power control for execution resources, e.g., for various blocks such as the fragment pipe 175, vertex pipe 185, ray intersect accelerator 190, matrix multiply accelerator 195, texture processing unit 165, etc. For example, software may request an interrupt from circuitry 250 when a block goes idle or active, access a live status register that indicates if a block is idle or active, configured circuitry 250 to control power off register writes for a block, configure a delay between circuitry 250 determining that a block has gone idle and sending the power off register write, etc.

As another example, power control circuitry 256 may determine that upcoming work (e.g., in one or more valid kick queues 244) will target GPU circuitry that is currently powered down. For example, a large kick that will likely be distributed across all mGPUs may cause circuitry 256 to wake all mGPUs. As another example, a kick with ray tracing work may cause circuitry 256 to wake ray intersect accelerator circuitry 190 in one or more mGPUs.

Power control circuitry 256 may also determine the number of instances of GPU circuitry to power on based on the size of a given kick or the number of kicks that target certain circuitry. For example, it may power on only a subset of mGPUs if only small kick(s) are enqueued or only a subset of specialized circuitry across mGPUs if less than a threshold number of kicks have specialized work for that circuitry.

Power control circuitry 256 may also consider priority information, e.g., queue priorities, when making power control decisions. For example, circuitry 256 may power on circuitry quickly when higher-priority work is enqueued but may wait longer for lower-priority work.

Power control circuitry 256 may implement hysteresis timers to delay powering circuitry down, in case additional work comes in. These delays may be shorter, however, relative to typical delays in software power control implementations, at least in some embodiments and situations.

In some embodiments, power control circuitry 256 considers the following top slot states as active states: waiting for resources, waiting for distributed slots, running, and halt requested. In some embodiments, power control circuitry 256 is configured not to power off any circuitry that has been assigned work from a top slot in one of these active states.

In some embodiments, power control circuitry 256 follow the following procedure to power off a block. If the block is idle, it starts a hysteresis timer. Once the timer expires, if the block is still idle, it pauses scheduling. If the block is still idle after scheduling is paused, circuitry 256 sends a power off write (and may send a fencing read to the power-off register). Once a confirmation response is received, circuitry 256 may resume scheduling (which may eventually cause the block to wake). This procedure may reduce power with limited impacts on performance, by reducing situations where new work comes in during the power down process a

Note that power processor 230, in some embodiments, may disable control by power control 256, at least in some operating modes. Further, power control circuitry 256 may have a range of control levels in different embodiments or scenarios, e.g., ranging from direct control of power gating circuitry (e.g., via power control registers that control gating logic) to providing interrupts to power processor 230 with suggestions for power actions (in which case power control circuitry 256 may set one or more status registers to indicate the reason for the interrupt and power processor 230 may perform various actions based on the indicated reason).

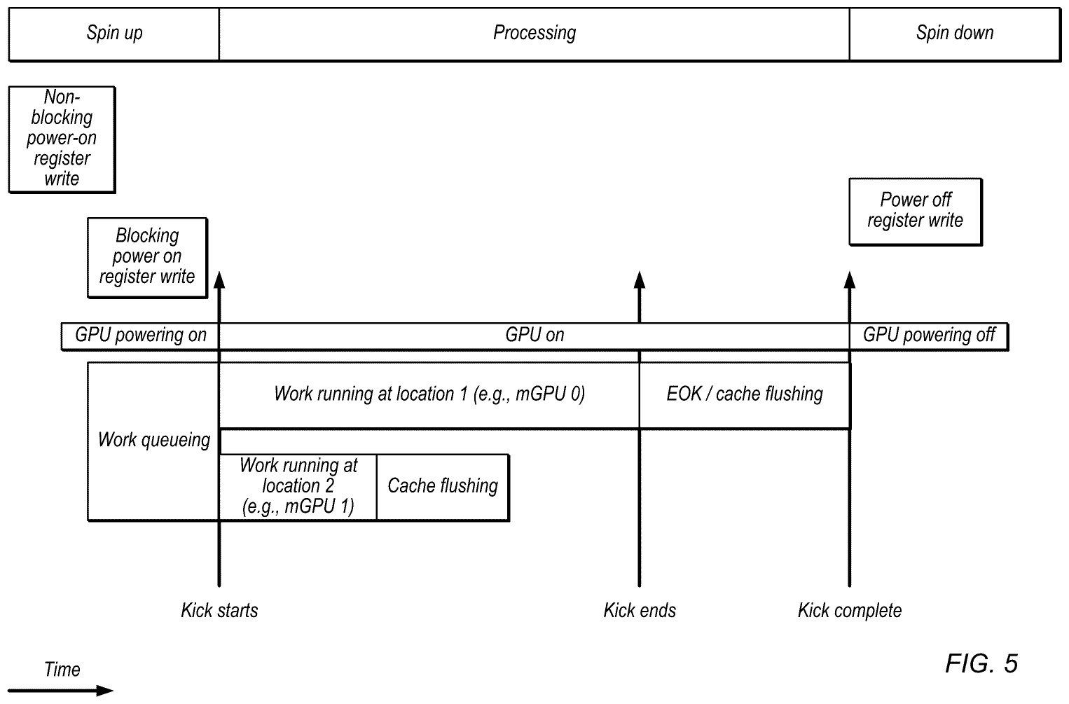

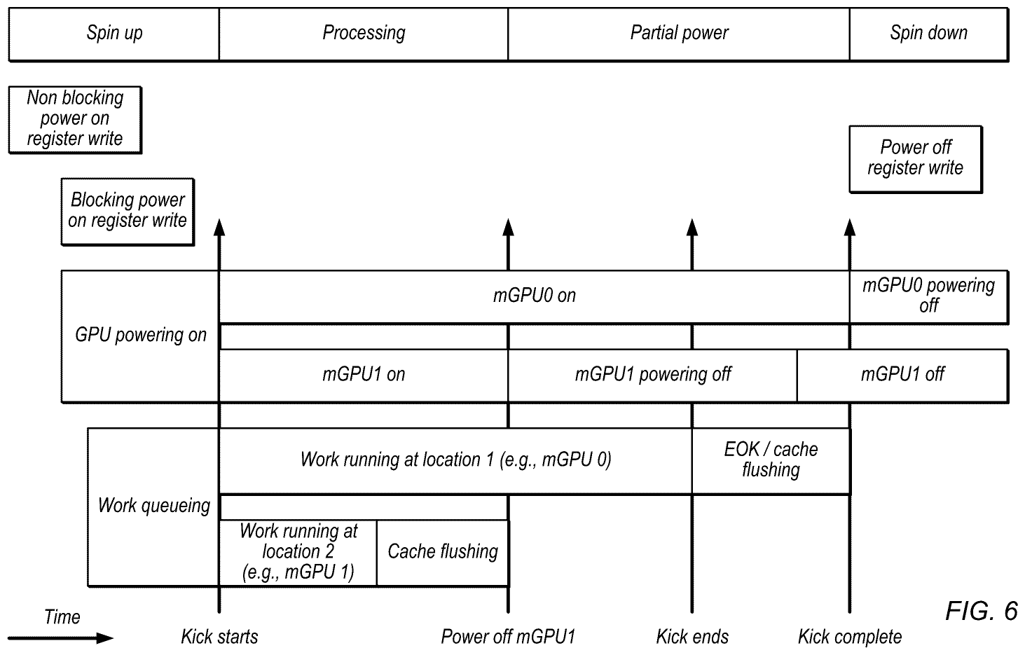

FIGS. 5 and 6 are timing diagrams illustrating example power control operations, contrasting broader control with fine-grained control, according to some embodiments. Note that the example of FIG. 5 may correspond to software control (e.g., power management firmware executed by power processor 230) while FIG. 6 may correspond to circuitry 250 participating in power control.

In the example of FIG. 5, there is a spin-up period for a kick, followed by a processing period, followed by a spin down period.

Specifically, power processor 230 performs a non-blocking power-on register write followed by a blocking power on register write. During this spin up interval, the GPU is powered on and work begins queuing, e.g., in a kick queue 244. Note that this spin-up interval may be shorter if direct host-based submission is utilized, relative to traditional techniques, regardless of whether power is controlled by software or hardware.

Once the GPU is powered on a kick is executed at two locations (mGPU 0 and mGPU1 in this example). The mGPU 1 finishes its work first and begins cache flushing. When mGPU 0 finishes its work, the kick ends, followed by an end of kick (EOK) command or procedure and cache flushing for mGPU 0's processing. When the cache flushing is complete, power processor 230 performs a power-off register write and the GPU begins powering off.

FIG. 6 is a timing diagram illustrating example power control operations with more granular control based on additional information available to slot manager circuitry, according to some embodiments. In this example, spin-up is similar (although circuitry 250 may participate in the power on register writes and power off register write in some embodiments, which may further reduce latency or improve power efficiency, e.g., by starting the GPU power-up sooner based on looking ahead at queue contents).

In this example, the row that starts with “GPU powering on” indicates the power state of mGPU0 and mGPU1 over time while the row that starts with “Work queueing” indicates the processing status of mGPU0 and mGPU1, for a kick, over time.

In this example, when mGPU1 is finished with its work and finishes cache flushing, circuitry 250 starts powering off mGPU1 such that it is powered off shortly after the end of the kick before mGPU0 is finished powering off. Thus, the overall GPU operates at partial power during this interval, reducing overall power consumption for execution of the kick. Generally, this is one example of more granular power control and hardware scheduler power control reducing overall power consumption.

### Example Method

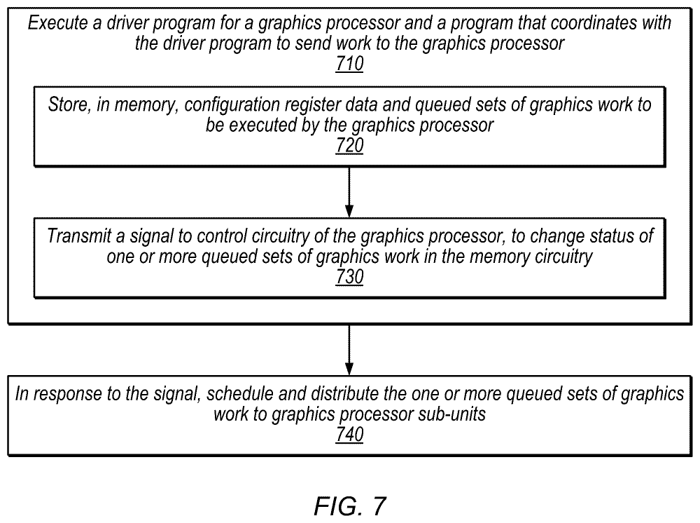

FIG. 7 is a flow diagram illustrating an example method for host-based GPU work submission, according to some embodiments. The method shown in FIG. 7 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 710, in the illustrated embodiment, a computing system (e.g., host processor 210) executes a driver program for a graphics processor and a program that coordinates with the driver program to send work to the graphics processor.

At 720, in the illustrated embodiment, the system stores, in memory, configuration register data and queued sets of graphics work to be executed by the graphics processor.

At 730, in the illustrated embodiment, the system transmits a signal to control circuitry of the graphics processor (e.g., to circuitry 259), to change status of one or more queued sets of graphics work in the memory circuitry. In some embodiments, the signal to the control circuitry is a write to a control register of the control circuitry (e.g., to a control register in stream control 252).

At 740, in the illustrated embodiment in response to the signal, the system (e.g., circuitry 250) schedules and distributes the one or more queued sets of graphics work to the graphics processor sub-units. For example, the distribution may send work to distributed work queues in one or more mGPUs 280.

In some embodiments, the system includes a firmware processor configured to control one or more operations of the graphics processor. In some embodiments, the signal by the processor to the control circuitry does not utilize the firmware processor and the firmware processor does not participate in launching the one or more queued sets of graphics work. Said another way, host-based submission may bypass the firmware processor when launching graphics work (although the firmware processor may be used for other tasks). For example, the one or more operations controlled by the firmware processor may: a page fault handling operation, a partial render operation, a context switch operation, etc., or some combination thereof.

In some embodiments, the control circuitry stores completion data for one or more executed sets of graphics work in a completion queue in the memory and provides a completion signal directly to the processor in response to storing the completion data. The processor may retrieve the completion data from the completion queue in response to the completion signal.

In some embodiments, the system includes a power control processor. In response to the signal in a paused scheduling state, the control circuitry may send an interrupt to the power control processor. In response to the interrupt, the power control processor may power on shader core circuitry of the graphics processor. In response to the shader core circuitry powering on, the power control processor may signal to the control circuitry to un-pause scheduling. In some embodiments, the processor is configured to send a programmable input/output (PIO) command to the control circuitry to wake the control circuitry from a power gated state.

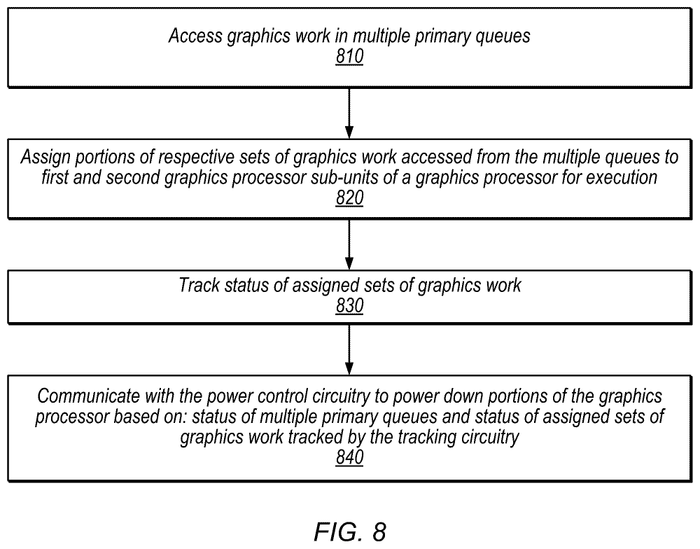

FIG. 8 is a flow diagram illustrating an example method for hardware scheduler circuitry control of GPU power actions, according to some embodiments. The method shown in FIG. 8 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 810, in the illustrated embodiment, a computing system (e.g., circuitry 250) accesses graphics work in multiple primary queues (e.g., memory queues).

At 820, in the illustrated embodiment, the computing system assigns portions of respective sets of graphics work accessed from the multiple queues to first and second graphics processor sub-units (e.g., mGPUs) for execution.

At 830, in the illustrated embodiment, the computing system tracks status of assigned sets of graphics work.

At 840, in the illustrated embodiment, the computing system communicates with power control circuitry to power down portions of the graphics processor based on: status of multiple queues and status of assigned sets of graphics work tracked by the tracking circuitry.

In some embodiments, the power control circuitry is configured to power down the first graphics processor sub-unit and not the second graphics processor sub-unit based on a request from the work control circuitry. In some embodiments, the power control circuitry is configured to power down the first graphics processor sub-unit while the second graphics processor sub-unit is still executing a portion of a same set of graphics work for which the first graphics processor sub-unit has completed execution of its portion. This fine-grained control may reduce power consumption without reducing performance.

In some embodiments, the portions of the graphics processor include one or more first portions of the first graphics processor sub-unit but not one or more second portions of the first graphics processor sub-unit. Said another way, power may be controlled at fine granularity within an mGPU, for example.

In some embodiments, the control of power state is based on a category of execution hardware of the graphics processor targeted by one or more sets of graphics work. For example, control circuitry may consider whether a set of work includes certain types of instructions (e.g., ray tracing instructions, sample instructions, matrix operations, integer/floating-point instructions, etc.) and use that information for power control decisions.

In some embodiments, the control of power state is based on a size of one or more sets of graphics work. For example, control circuitry may power down some mGPUs when relatively smaller kicks are queued. In some embodiments, the control of power state is based on priorities of the multiple primary queues. For example, the control circuitry may maintain a more aggressive (more-on) power profile when higher priority queues have work.

In some embodiments (e.g., that implement logical kickslots), the first and second graphics processor sub-units further include configuration registers configured to store control register data corresponding to stored graphics work. In some embodiments, the multiple primary queues are stored in a data structure in memory and respective queues enqueue control information for multiple sets of graphics work. In some embodiments, the work control circuitry is configured to assign sets of graphics work to logical slots and map a logical slot to multiple graphics processor sub-units to distribute portions of a set of graphics work assigned to the logical slot to multiple distributed hardware slots of multiple graphics processor sub-units.

As used herein, the term “compute kernel” in the graphics context is intended to be interpreted according to its well-understood meaning, which includes a routine compiled for acceleration hardware such as a graphics processor. Kernels may be specified by a separate program language such as OpenCL C, may be written as compute shaders in a shading language such as OpenGL, or embedded in application code in a high level language, for example. Compute kernels typically include a number of workgroups which in turn include a number of workitems (also referred to as threads).

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

### Example Device

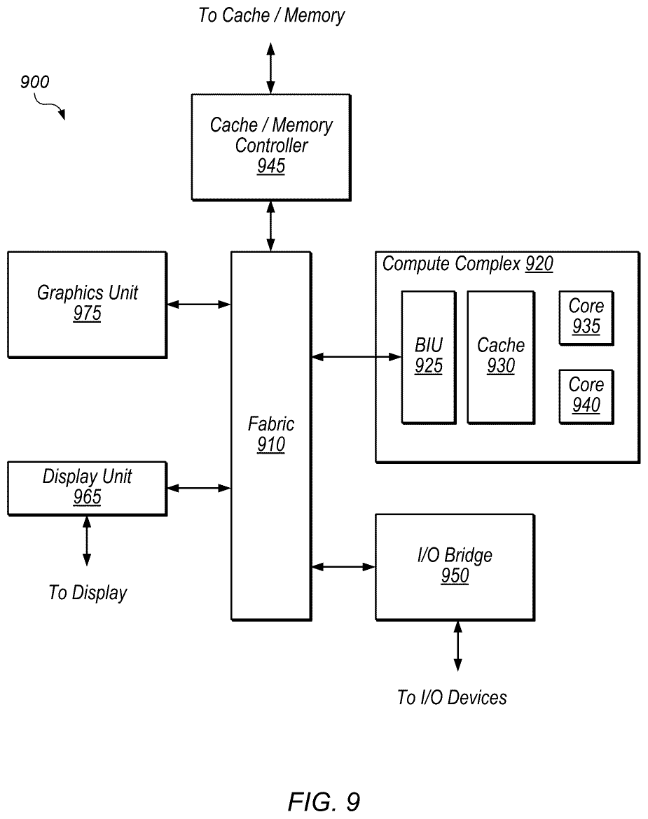

Referring now to FIG. 9, a block diagram illustrating an example embodiment of a device 900 is shown. In some embodiments, elements of device 900 may be included within a system on a chip. In some embodiments, device 900 may be included in a mobile device, which may be battery-powered. Therefore, power consumption by device 900 may be an important design consideration. In the illustrated embodiment, device 900 includes fabric 910, compute complex 920 input/output (I/O) bridge 950, cache/memory controller 945, graphics unit 975, and display unit 965. In some embodiments, device 900 may include other components (not shown) in addition to or in place of the illustrated components, such as video processor encoders and decoders, image processing or recognition elements, computer vision elements, etc.

Fabric 910 may include various interconnects, buses, MUX's, controllers, etc., and may be configured to facilitate communication between various elements of device 900. In some embodiments, portions of fabric 910 may be configured to implement various different communication protocols. In other embodiments, fabric 910 may implement a single communication protocol and elements coupled to fabric 910 may convert from the single communication protocol to other communication protocols internally.

In the illustrated embodiment, compute complex 920 includes bus interface unit (BIU) 925, cache 930, and cores 935 and 940. In various embodiments, compute complex 920 may include various numbers of processors, processor cores and caches. For example, compute complex 920 may include 1, 2, or 4 processor cores, or any other suitable number. In one embodiment, cache 930 is a set associative L2 cache. In some embodiments, cores 935 and 940 may include internal instruction and data caches. In some embodiments, a coherency unit (not shown) in fabric 910, cache 930, or elsewhere in device 900 may be configured to maintain coherency between various caches of device 900. BIU 925 may be configured to manage communication between compute complex 920 and other elements of device 900. Processor cores such as cores 935 and 940 may be configured to execute instructions of a particular instruction set architecture (ISA) which may include operating system instructions and user application instructions. These instructions may be stored in computer readable medium such as a memory coupled to memory controller 945 discussed below.

As used herein, the term “coupled to” may indicate one or more connections between elements, and a coupling may include intervening elements. For example, in FIG. 9, graphics unit 975 may be described as “coupled to” a memory through fabric 910 and cache/memory controller 945. In contrast, in the illustrated embodiment of FIG. 9, graphics unit 975 is “directly coupled” to fabric 910 because there are no intervening elements.

Cache/memory controller 945 may be configured to manage transfer of data between fabric 910 and one or more caches and memories. For example, cache/memory controller 945 may be coupled to an L3 cache, which may in turn be coupled to a system memory. In other embodiments, cache/memory controller 945 may be directly coupled to a memory. In some embodiments, cache/memory controller 945 may include one or more internal caches. Memory coupled to controller 945 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 945 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 920 to cause the computing device to perform functionality described herein.

Graphics unit 975 may include one or more processors, e.g., one or more graphics processing units (GPUs). Graphics unit 975 may receive graphics-oriented instructions, such as OPENGL®, Metal®, or DIRECT3D® instructions, for example. Graphics unit 975 may execute specialized GPU instructions or perform other operations based on the received graphics-oriented instructions. Graphics unit 975 may generally be configured to process large blocks of data in parallel and may build images in a frame buffer for output to a display, which may be included in the device or may be a separate device. Graphics unit 975 may include transform, lighting, triangle, and rendering engines in one or more graphics processing pipelines. Graphics unit 975 may output pixel information for display images. Graphics unit 975, in various embodiments, may include programmable shader circuitry which may include highly parallel execution cores configured to execute graphics programs, which may include pixel tasks, vertex tasks, and compute tasks (which may or may not be graphics-related).

Display unit 965 may be configured to read data from a frame buffer and provide a stream of pixel values for display. Display unit 965 may be configured as a display pipeline in some embodiments. Additionally, display unit 965 may be configured to blend multiple frames to produce an output frame. Further, display unit 965 may include one or more interfaces (e.g., MIPI® or embedded display port (eDP)) for coupling to a user display (e.g., a touchscreen or an external display).

I/O bridge 950 may include various elements configured to implement: universal serial bus (USB) communications, security, audio, and low-power always-on functionality, for example. I/O bridge 950 may also include interfaces such as pulse-width modulation (PWM), general-purpose input/output (GPIO), serial peripheral interface (SPI), and inter-integrated circuit (I2C), for example. Various types of peripherals and devices may be coupled to device 900 via I/O bridge 950.

In some embodiments, device 900 includes network interface circuitry (not explicitly shown), which may be connected to fabric 910 or I/O bridge 950. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 900 with connectivity to various types of other devices and networks.

### Example Applications

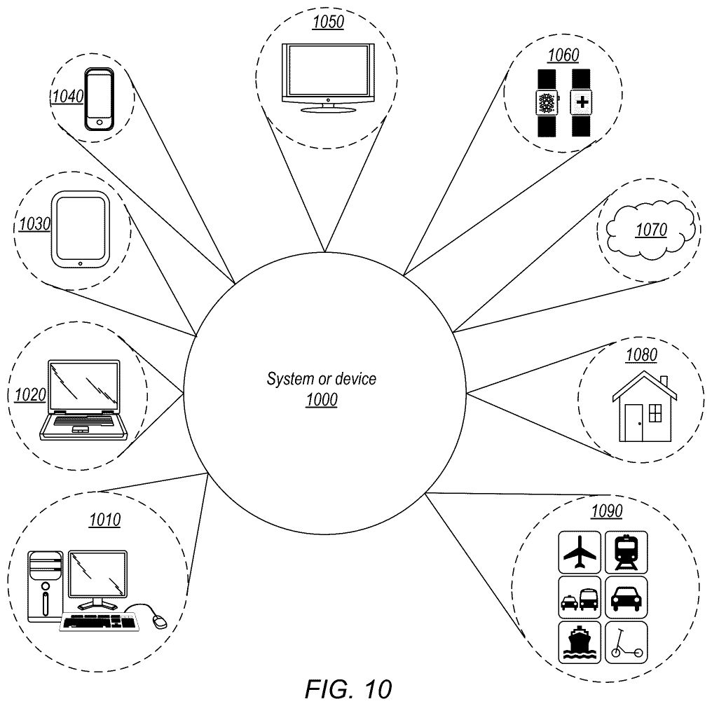

Turning now to FIG. 10, various types of systems that may include any of the circuits, devices, or system discussed above. System or device 1000, which may incorporate or otherwise utilize one or more of the techniques described herein, may be utilized in a wide range of areas. For example, system or device 1000 may be utilized as part of the hardware of systems such as a desktop computer 1010, laptop computer 1020, tablet computer 1030, cellular or mobile phone 1040, or television 1050 (or set-top box coupled to a television).

Similarly, disclosed elements may be utilized in a wearable device 1060, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1000 may also be used in various other contexts. For example, system or device 1000 may be utilized in the context of a server computer system, such as a dedicated server or on shared hardware that implements a cloud-based service 1070. Still further, system or device 1000 may be implemented in a wide range of specialized everyday devices, including devices 1080 commonly found in the home such as refrigerators, thermostats, security cameras, etc. The interconnection of such devices is often referred to as the “Internet of Things” (IoT). Elements may also be implemented in various modes of transportation. For example, system or device 1000 could be employed in the control systems, guidance systems, entertainment systems, etc. of various types of vehicles 1090.

The applications illustrated in FIG. 10 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

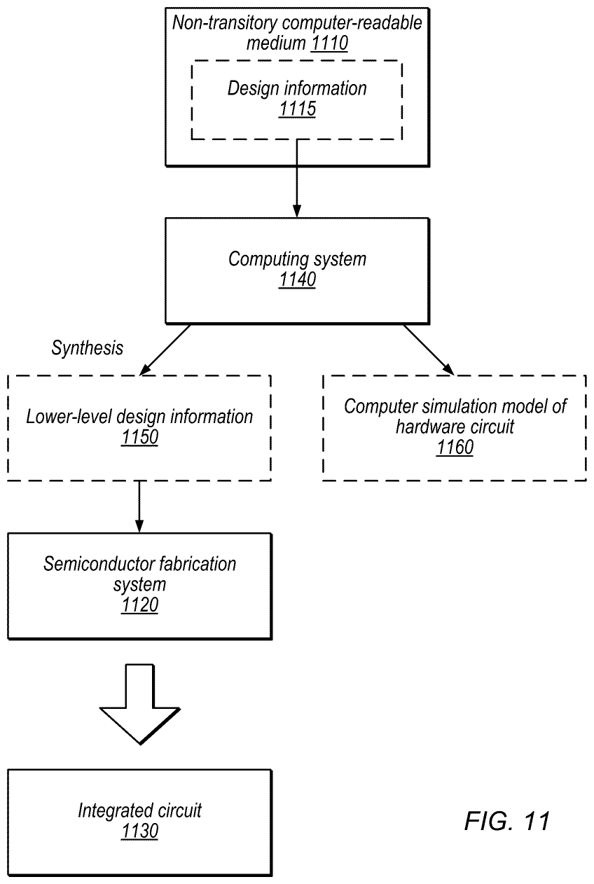

FIG. 11 is a block diagram illustrating an example non-transitory computer-readable storage medium that stores circuit design information, according to some embodiments. In the illustrated embodiment, computing system 1140 is configured to process the design information. This may include executing instructions included in the design information, interpreting instructions included in the design information, compiling, transforming, or otherwise updating the design information, etc. Therefore, the design information controls computing system 1140 (e.g., by programming computing system 1140) to perform various operations discussed below, in some embodiments.

In the illustrated example, computing system 1140 processes the design information to generate both a computer simulation model of a hardware circuit 1160 and lower-level design information 1150. In other embodiments, computing system 1140 may generate only one of these outputs, may generate other outputs based on the design information, or both. Regarding the computing simulation, computing system 1140 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1140 also processes the design information to generate lower-level design information 1150 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1150 (potentially among other inputs), semiconductor fabrication system 1120 is configured to fabricate an integrated circuit 1130 (which may correspond to functionality of the simulation model 1160). Note that computing system 1140 may generate different simulation models based on design information at various levels of description, including information 1150, 1115, and so on. The data representing design information 1150 and model 1160 may be stored on medium 1110 or on one or more other media.

In some embodiments, the lower-level design information 1150 controls (e.g., programs) the semiconductor fabrication system 1120 to fabricate the integrated circuit 1130. Thus, when processed by the fabrication system, the design information may program the fabrication system to fabricate a circuit that includes various circuitry disclosed herein.

Non-transitory computer-readable storage medium 1110, may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1110 may include other types of non-transitory memory as well or combinations thereof. Accordingly, non-transitory computer-readable storage medium 1110 may include two or more memory media; such media may reside in different locations—for example, in different computer systems that are connected over a network.

Design information 1115 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1140, semiconductor fabrication system 1120, or both. In some embodiments, design information may also include one or more cell libraries that specify the synthesis, layout, or both of integrated circuit 1130. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1130 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 and model 1160 are configured to operate according to a circuit design specified by design information 1115, which may include performing any of the functionality described herein. For example, integrated circuit 1130 may include any of various elements shown in FIGS. 1B-4 and 9. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1120 to fabricate integrated circuit 1130.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as Cor C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
a graphics processor, comprising control circuitry configured to schedule and distribute different portions of sets of assigned graphics work to multiple different graphics processor sub-units;
memory circuitry; and
a processor configured to execute a driver program for the graphics processor and a program that coordinates with the driver program to send work to the graphics processor, including to:
store, in the memory circuitry, configuration register data and queued sets of graphics work to be executed by the graphics processor; and
transmit a signal, to the control circuitry of the graphics processor, to change status of one or more queued sets of graphics work in the memory circuitry;
wherein, in response to the signal, the control circuitry is configured to schedule and distribute the one or more queued sets of graphics work to the graphics processor sub-units.

2. The apparatus of claim 1, wherein the signal to the control circuitry is a write to a control register of the control circuitry.

3. The apparatus of claim 1, further comprising:
a firmware processor configured to control one or more operations of the graphics processor;
wherein the signal by the processor to the control circuitry does not utilize the firmware processor and the firmware processor does not participate in launching the one or more queued sets of graphics work.

4. The apparatus of claim 3, wherein the one or more operations controlled by the firmware processor include at least:
a page fault handling operation;
a partial render operation; and
a context switch operation.

5. The apparatus of claim 1, wherein the control circuitry is configured to:
store completion data for one or more executed sets of graphics work in a completion queue in the memory; and
provide a completion signal directly to the processor in response to storing the completion data, wherein the processor is configured to retrieve the completion data from the completion queue in response to the completion signal.

6. The apparatus of claim 1, further comprising:
a power control processor;
wherein:
in response to the signal in a paused scheduling state, the control circuitry is configured to send an interrupt to the power control processor;
in response to the interrupt, the power control processor is configured to power on shader core circuitry of the graphics processor; and
in response to the shader core circuitry powering on, the power control processor is configured to signal to the control circuitry to un-pause scheduling.

7. The apparatus of claim 1, wherein the processor is configured to send a programmable input/output (PIO) command to the control circuitry to wake the control circuitry from a power gated state.

8. The apparatus of claim 1, wherein
the control circuitry is kickslot manager circuitry that includes tracking slot circuitry configured to store software-accessible status information for tracking slots;
the kickslot manager circuitry is configured to assign tracking slots to logical kickslots; and
the kickslot manager circuitry is configured to distribute graphics work from logical kickslots to distributed hardware kickslots in the different graphics processor sub-units.

9. The apparatus of claim 1, wherein the apparatus is a computing device that further includes:
a central processing unit;
a display; and
network interface circuitry.

10. A non-transitory computer-readable medium having instructions of a graphics driver program stored thereon that are executable by a computing device to perform operations comprising:
storing, in memory, configuration register data and queued sets of graphics work to be executed by a graphics processor; and
transmitting a signal, to control circuitry of the graphics processor, to change status of one or more queued sets of graphics work in the memory;
wherein, in response to the signal, the control circuitry schedules and distributes the one or more queued sets of graphics work to graphics processor sub-units.

11. The non-transitory computer-readable medium of claim 10, wherein the signal is a write to a control register of the control circuitry.

12. The non-transitory computer-readable medium of claim 10, wherein the signal by the processor to the control circuitry bypasses a firmware processor of the graphics processor.

13. The non-transitory computer-readable medium of claim 10, wherein the operations further comprise:
receive a signal from the graphics processor that indicates completion of one or more executed sets of graphics work; and
retrieve completion data from a completion queue in response to the signal from the graphics processor.

14. A method, comprising:
executing, by a processor, a driver program for a graphics processor and a program that coordinates with the driver program to send work to the graphics processor;
storing, by the processor in memory circuitry, configuration register data and queued sets of graphics work to be executed by the graphics processor;
transmitting, by the processor to control circuitry of the graphics processor, a signal to change status of one or more queued sets of graphics work in the memory circuitry; and
scheduling and distributing, by the control circuitry, distribute different portions of queued sets of assigned graphics work to multiple different graphics processor sub-units, in response to the signal.

15. The method of claim 14, wherein the signal to the control circuitry is a write to a control register of the control circuitry.

16. The method of claim 14, wherein:
the graphics processor includes a firmware processor configured to control one or more operations of the graphics processor; and
the signal by the processor to the control circuitry does not utilize the firmware processor and the firmware processor does not participate in launching the one or more queued sets of graphics work.

17. The method of claim 14, further comprising:
storing, by the control circuitry, completion data for one or more executed sets of graphics work in a completion queue in the memory;
providing, by the control circuitry, a completion signal directly to the processor in response to storing the completion data; and
retrieving, by the processor, the completion data from the completion queue in response to the completion signal.

18. The method of claim 14, further comprising:
in response to the signal in a paused scheduling state, the control circuitry sending an interrupt to a power control processor;
in response to the interrupt, the power control processor powering on shader core circuitry of the graphics processor; and
in response to the shader core circuitry powering on, the power control processor signaling to the control circuitry to un-pause scheduling.

19. The method of claim 14, further comprising:
sending, by the processor, a programmable input/output (PIO) command to the control circuitry to wake the control circuitry from a power gated state.

20. The method of claim 14, wherein the control circuitry is kickslot manager circuitry that includes tracking slot circuitry configured to store software-accessible status information for tracking slots, the method further comprising:
the control circuitry assigning tracking slots to logical kickslots; and
the control circuitry distributing graphics work from logical kickslots to distributed hardware kickslots in the different graphics processor sub-units.
